(19) United States
(12) Patent Application Publication
(10) Pub. No.: US 2014/0064121 A1
(43) Pub. Date: Mar. 6, 2014

(54) WIRELESS COMMUNICATION APPARATUS

(71) Applicant: TOSHIBA TEC KABUSHIKI KAISHA, Tokyo (JP)

(72) Inventor: Takashi Ootashiro, Shizuoka-ken (JP)

(73) Assignee: TOSHIBA TEC KABUSHIKI KAISHA, Tokyo (JP)

(21) Appl. No.: 13/960,981

(22) Filed: Aug. 7, 2013

(30) Foreign Application Priority Data
Aug. 30, 2012 (JP) 2012-189786

(51) Int. Cl. H04W 88/08

(52) U.S. Cl. CPC H04W 88/08
USPC 370/252

(57) ABSTRACT

The strength of electric wave which is transmitted from a wireless communication terminal and received through a leaky coaxial cable is detected. Data transmission is executed to the wireless communication terminal by transmitting the electric wave from the leaky coaxial cable if the detected strength of the electric wave is equal to or greater than a set value, which is changed according to time.

### CROSS-REFERENCE TO RELATED APPLICATION

This application is based upon and claims the benefit of priority from Japanese Patent Application No. 2012-189786, filed Aug. 30, 2012, the entire contents of which are incorporated herein by reference.

### FIELD

Embodiments described herein relate to a wireless communication apparatus in which a leaky coaxial cable is used as an antenna.

### BACKGROUND

A wireless LAN area, i.e. a so-called free spot, can be formed around a leaky coaxial cable used as an antenna.

### BRIEF DESCRIPTION OF THE DRAWINGS

FIG. 1 is a diagram illustrating the configuration and a communicable range of a wireless communication apparatus according to one embodiment;

FIG. 2 is a block diagram of an access point according to the embodiment;

FIG. 3 is a flowchart illustrating the control of the access point according to the embodiment;

FIG. 4 is a graph illustrating a relationship between the time and a transmission rate according to the embodiment;

FIG. 5 is a table illustrating a relationship between a link speed and a received signal strength according to the embodiment; and

FIG. 6 is a graph illustrating a relationship between the link speed (and the received signal strength) and a communicable distance according to the embodiment.

### DETAILED DESCRIPTION

In accordance with one embodiment, a wireless communication apparatus includes a leaky coaxial cable, a detection module and a control module. The leaky coaxial cable carries out transmission and reception of electric wave. The detection module detects the strength of the electric wave which is transmitted from a wireless communication terminal and received through the leaky coaxial cable. The control module executes data transmission to the wireless communication terminal by transmitting the electric wave from the leaky coaxial cable if the strength of the electric wave detected by the detection unit module is equal to or greater than a set value, and changes the set value according to time.

One embodiment is described below with reference to the accompanying drawings.

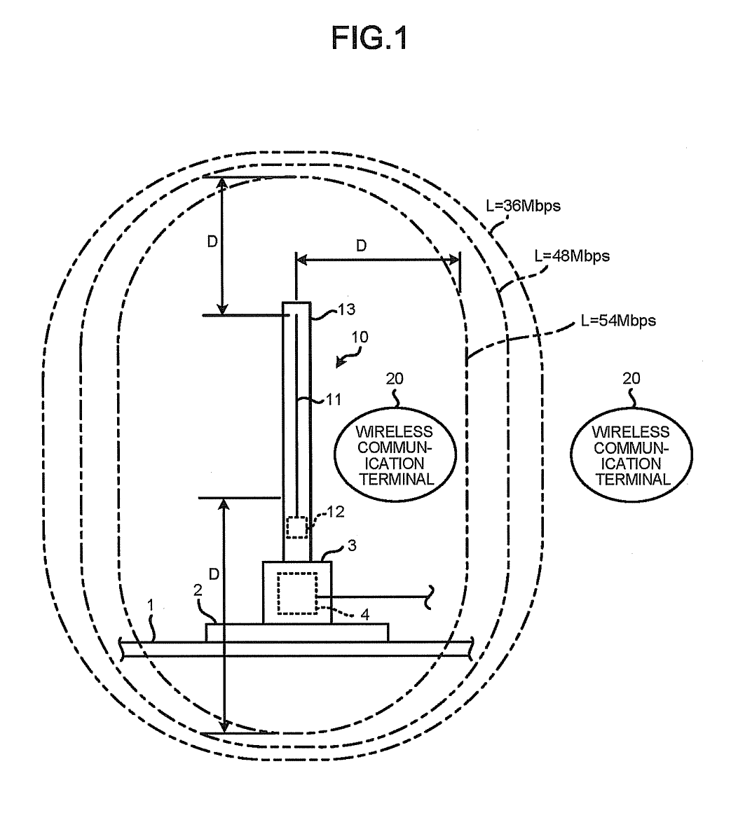

As shown in FIG. 1, a disc-shaped base station 2 is arranged on an installation surface 1 such as a floor, a ceiling, a table and the like. A tower-shaped antenna 10 is vertically arranged on the base station 2 via a cylindrical housing 3. The antenna 10 includes a linear leaky coaxial cable 11 which carries out a transmission and reception of electric wave, an attenuator 12 which attenuates the electric wave (equal to a high frequency electric power supplied to the leaky coaxial cable 11) transmitted from the leaky coaxial cable 11 and a cylindrical cover 13 which covers the leaky coaxial cable 11 and the attenuator 12.

The leaky coaxial cable 11 is also referred to as an LCX cable having a plurality of slots for transmitting (leaking) and receiving the electric wave along the axial direction thereof. A wireless LAN area, i.e. a so-called free spot (also referred to as a service area), which is shown by long dashed double-dotted lines, is formed around the antenna 10 including the leaky coaxial cable 11. A wireless communication terminal 20 can be used to carry out a wireless communication freely in the free spot. The attenuator 12 is attached if the strength of the electric wave transmitted from the leaky coaxial cable 11 is intended to be attenuated, or is removed if the strength of the electric wave is not intended to be attenuated. It can be constituted that a plurality of attenuators 12 with different amounts in attenuation are prepared and anyone of which is attached selectively.

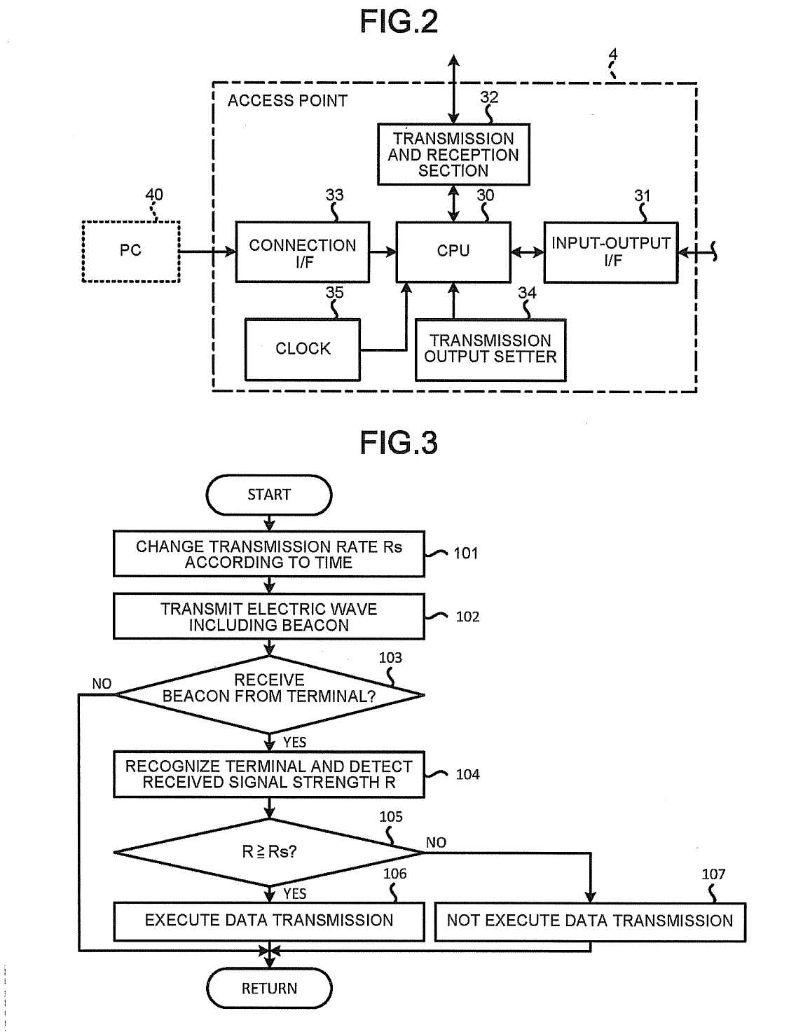

The housing 3, in addition to supporting the antenna 10, also houses a transmission/reception unit, i.e. a so-called access point 4 for transmitting and receiving data. As shown in FIG. 2, the access point 4 includes a CPU 30 which functions as a main control section, an input-output interface 31 which is connected to an external communication network, a transmission/reception section 32 which carries out the transmission and reception of electric wave, a connection interface 33 for connecting with an external device, a transmission output setter 34, a clock 35 and the like.

The transmission/reception section 32 superimposes a signal and data responding to the instruction from the CPU 30 on the high frequency electric power to transmit it to the leaky coaxial cable 11, on the one hand, and extracts a signal and data included in the electric wave received through the leaky coaxial cable 11 to supply it to the CPU 30, on the other hand.

The connection interface 33 is applied to the connection with the external device such as a personal computer 40. The transmission output setter 34 is applied to setting the high frequency electric power (equal to the strength of the electric wave transmitted from the leaky coaxial cable 11) output from the transmission/reception section 32, and includes a volume knob for operation. The clock 35 measures a time at 24-hours interval.

Moreover, the CPU 30 includes the following modules (1)-(4) as main functions.

(1) A recognition module which recognizes the wireless communication terminal 20 which exists in a reaching area of the electric wave transmitted from the leaky coaxial cable 11 based on the identification data in a beacon included in the electric wave transmitted from the wireless communication terminal 20. Specifically, a beacon specific to the access point 4 is periodically transmitted by the electric wave transmission from the leaky coaxial cable 11, in response to the beacon transmitted, the electric wave transmitted from the wireless communication terminal 20 and a beacon included in the electric wave are received, and the wireless communication terminal 20 is recognized based on the identification data included in the received beacon. With this recognition, each wireless communication terminal 20 can be recognized respectively, even though a plurality of wireless communication terminals 20 exist in the reaching area of the electric wave.

(2) A detection module which detects the strength of the electric wave which is transmitted from the recognized wireless communication terminal 20 and received through the leaky coaxial cable 11. Specifically, the detection module includes a part of the functions of the recognition unit, and detects the signal strength of the beacon, i.e. a so-called received signal strength R (%), included in the electric wave transmitted from the wireless communication terminal 20 in response to the periodical transmission of the beacon in the electric wave received through the leaky coaxial cable 11. The received signal strength R is referred to as an RSSI (Received Signal Strength Indication).

(3) A control unit which executes a data transmission to the recognized wireless communication terminal 20 by the electric wave transmission from the leaky coaxial cable 11 if the received signal strength R detected by the detection module is equal to or greater than the set value Rs, and does not execute the data transmission if the received signal strength R is less than the set value Rs, and moreover, change the set value Rs according to time. The set value Rs is hereinafter referred to as a transmission rate Rs.

(4) A setting unit configured to module which variably sets the high frequency electric power output from the transmission/reception section 32, i.e. the strength of the electric wave transmitted from the leaky coaxial cable 11 according to the operation of the volume knob of the transmission output setter 34.

Next, the control executed by the CPU 30 of the access point 4 is described with reference to the flowchart in FIG. 3.

First, the CPU 30 changes the transmission rate Rs stored in an internal memory according to the time (ACT 101). Specifically, the transmission rate Rs is made to be different at a plurality of time zones in one day based on the time-counting of the clock 35.

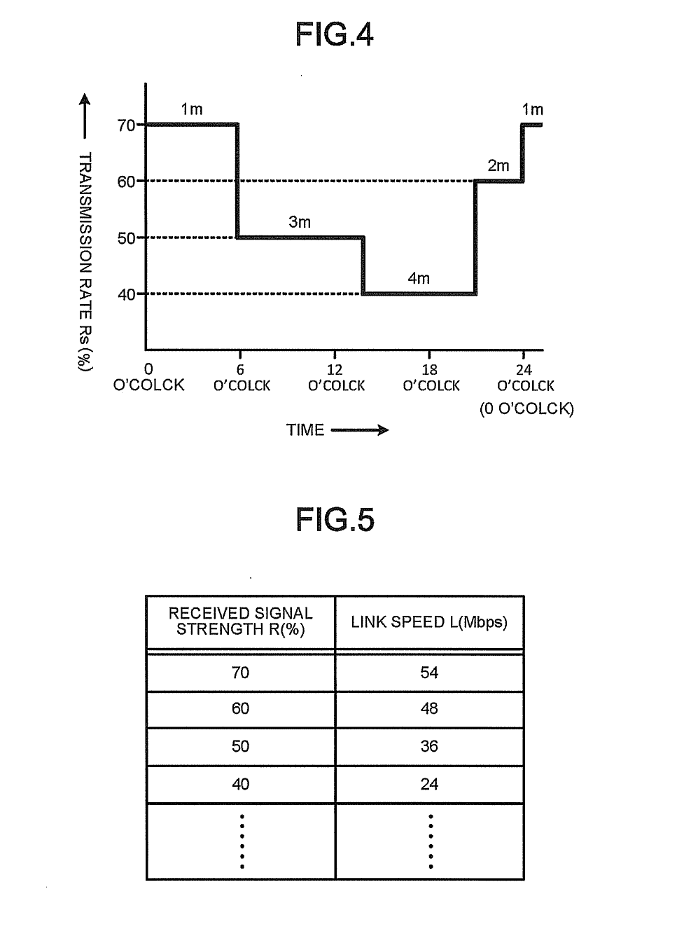

That is, as shown in FIG. 4, the transmission rate Rs is set to 70(%) at a time zone from 0 am (equal to 24 o'clock) to 7 am at which people have less activities. The transmission rate Rs is set to 50(%) at a time zone from 7 am to 2 pm (equal to 14 o'clock) at which people have more activities. The transmission rate Rs is set to 40(%) at a time zone from 2 pm to 9 pm (equal to 21 o'clock) at which people have more activities and use of the wireless communication apparatus is in an increasing tendency. While the transmission rate Rs is set to 60(%) at a time zone from 9 pm to 0 am at which activities of people decrease.

The relation between the time zone and the transmission rate Rs can be appropriately changed according to the installation side and conditions in use of the apparatus such that a personal computer 40 is connected with the connection interface 33 and the data of the apparatus described above is input from the personal computer 40.

CPU 30 superimposes a beacon specific to the access point 4 on the high frequency electric power, and periodically (for each control loop) transmits the electric wave with the high frequency electric power from the leaky coaxial cable 11 (ACT 102). The transmitted electric wave can reach a point about 50 m apart if there is no obstacle and the like.

The wireless communication terminal 20 receiving the electric wave transmits electric wave including a beacon specific to the wireless communication terminal 20 in response to the beacon included in the electric wave received.

If the electric wave received through the leaky coaxial cable 11 includes the beacon (YES in ACT 103), the CPU 30 recognizes the wireless communication terminal 20 serving as a transmitting source based on the identification data included in the beacon and detects the received signal strength R of the same beacon (ACT 104).

A communication speed, i.e. a so-called link speed L (Mbps), exists between the wireless communication terminal 20 and the access point 4 in the reaching area of the electric wave transmitted from the leaky coaxial cable 11 and the communication speed is determined by the transmission loss therebetween. As shown in FIG. 5, the link speed L is in a relationship corresponding to the received signal strength (RSSI) R. For example, in order to obtain the link speed L=54 (Mbps), the received signal strength R must be set to be at least 70(%). In order to obtain the link speed L=48 (Mbps), the received signal strength R must be set to be at least 60(%). In order to obtain the link speed L=36 (Mbps), the received signal strength R must be set to be at least 50(%). In order to obtain the link speed L=24 (Mbps), the received signal strength R must be set to be at least 40(%).

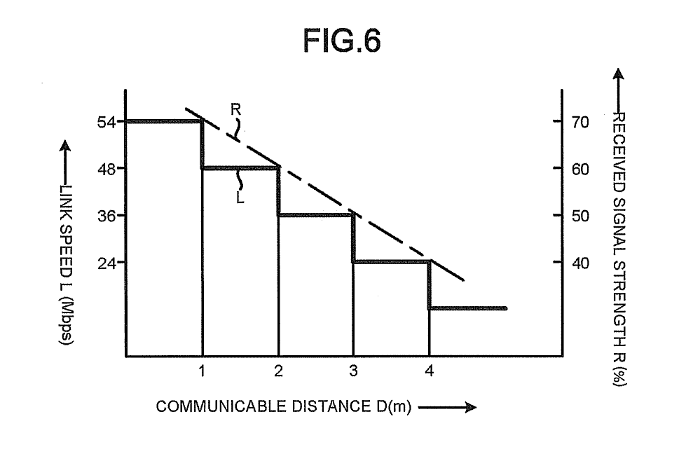

In addition, as shown in FIG. 6, the link speed L is in a relationship corresponding to a communicable distance D. For example, the communicable distance D is about 1 m if the link speed L is 54 (Mbps), the communicable distance D is about 2 m if the link speed L is 48 (Mbps), the communicable distance D is about 3 m if the link speed L is 36 (Mbps) and the communicable distance D is about 4 m if the link speed L is 24 (Mbps).

As shown by the long dashed double-dotted lines in FIG. 1, the actual communicable distances D are respectively, in the horizontal direction from the leaky coaxial cable 11, in the upward direction from the upper end of the leaky coaxial cable 11 and in the downward direction from the lower end of the leaky coaxial cable 11, and the wireless LAN area, i.e. a so-called free spot, is a substantially cylindrical area specified by these communicable distances D.

The CPU 30 compares the detected received signal strength R with a preset transmission rate Rs (ACT 105). And then, if the received signal strength R is equal to or greater than the transmission rate Rs (Yes in ACT 105), data transmission is executed to the recognized wireless communication terminal 20 (ACT 106). If the received signal strength R is less than the transmission rate Rs (No in ACT 105), the data transmission is not executed to the recognized wireless communication terminal 20 (ACT 107).

For example, if the transmission rate Rs is 40(%), data transmission is executed to the wireless communication terminal 20 the received signal strength R from which is equal to or greater than 40(%), and the data transmission is not executed to the wireless communication terminal 20 the received signal strength R from which is less than 40(%). In a case that the received signal strength R is equal to or greater than 40(%), the data transmission is executed only to the wireless communication terminal 20 which is located within 4 m within which the link speed L is maintained at 24 (Mbps). Therefore, the data transmission is not executed to the wireless communication terminal 20 which is located beyond 4 m. The data transmission is executed, however, if the wireless communication terminal 20 located beyond 4 m moves into the range of 4 m. And the data transmission is not executed if the wireless communication terminal 20 located within 4 m moves out the range of 4 m again.

If the transmission rate Rs is 50(%), the data transmission is executed to the wireless communication terminal 20 the received signal strength R from which is equal to or greater than 50(%), and the data transmission is not executed to the wireless communication terminal 20 the received signal strength R from which is less than 50(%). In a case in which the received signal strength R is equal to or greater than 50(%), the data transmission is executed only to the wireless communication terminal 20 located within 3 m within which the link speed L is maintained at 36(Mbps). The data transmission is not executed to the wireless communication terminal 20 located beyond 3 m. The data transmission is executed if the wireless communication terminal 20 located beyond 3 m moves into the range of 3 m. And the data transmission is not executed if the wireless communication terminal 20 located within 3 m moves out the range of 3 m again.

If the transmission rate Rs is 60(%), the data transmission is executed to the wireless communication terminal 20 the received signal strength R from which is equal to or greater than 60(%), and the data transmission is not executed to the wireless communication terminal 20 the received signal strength R from which is less than 60(%). In a case that the received signal strength R is equal to or greater than 60(%), the data transmission is executed only to the wireless communication terminal 20 located within 2 m within which the link speed L is maintained at 48 (Mbps). The data transmission is not executed to the wireless communication terminal 20 located beyond 2 m. The data transmission is executed if the wireless communication terminal 20 located beyond 2 m moves into the range of 2 m. And the data transmission is not executed if the wireless communication terminal 20 located within 2 m moves out the range of 2 m again.

If the transmission rate Rs is 70(%), the data transmission is executed to the wireless communication terminal 20 the received signal strength R from which is equal to or greater than 70(%), and the data transmission is not executed to the wireless communication terminal 20 the received signal strength R from which is less than 70(%). In a case that the received signal strength R is equal to or greater than 70(%), the data transmission is executed only to the wireless communication terminal 20 located within 1 m within which the link speed L is maintained at 54 (Mbps). The data transmission is not executed to the wireless communication terminal 20 located beyond 1 m. The data transmission is executed if the wireless communication terminal 20 located beyond 1 m moves into the range of 1 m. And the data transmission is not executed if the wireless communication terminal 20 located within 1 m moves out the range of 1 m again.

Even if the electric wave transmitted from the leaky coaxial cable 11 reaches a point about 50 m apart by selectively setting a plurality of transmission rates Rs, the actual data communication can be exactly restricted in the free spot of an expected range regardless of the reaching distance of the electric wave. The wireless communication with the wireless communication terminal 20 located beyond the free spot is cut off, therefore, the security and reliability of the wireless communication can be also increased.

In addition to the above, the transmission rates Rs are made to be different for the plurality of time zones in one day, and therefore, the size of the free spot can be adjusted according to change in the activity amount of people, and frequency in use of the apparatus.

That is, in consideration of less people carrying out the wireless communication with the apparatus and security aspects such as a regional security and the like at the time zone from 0 am in mid-night (equal to 24 o'clock) to 7 am, the transmission rate Rs is set at 70(%) to form a small free spot with the range of about 1 m. With the determination that the number of people who carry out the wireless communication with the apparatus is increased at the time zone from 7 am to 2 pm (equal to 14 o'clock), the transmission rate Rs is set at 50(%) to form a large free spot with the range of about 3 m.

With the determination that the number of people who carry out the wireless communication with the apparatus is further increased at the time zone from 2 pm to 9 pm (equal to 21 o'clock), the transmission rate Rs is set at 40(%) to enlarge the range of the free spot to be about 4 m. With the determination that the number of people who carry out the wireless communication with the apparatus is greatly reduced at the time zone from 9 pm to 0 am, the transmission rate Rs is set at 60(%) to decrease the range of the free spot to be about 2 m.

In this way, the versatility of the apparatus is greatly expanded by adjusting the size of the free spot according to the plurality of time zones. That is, it can be applied to various purposes in use of the users who introduce this apparatus as wireless communication equipment.

Further, in the embodiment described above, the description is given referring to the vertically arranged antenna 10 as an example, however, the state in which the antenna 10 is installed in parallel with the floor, the state in which the antenna 10 inclines in a specific angle and the state in which the antenna 10 is hung from the ceiling can be also embodied.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A wireless communication apparatus, comprising:
a leaky coaxial cable configured to carry out transmission and reception of electric wave;
a detection module configured to detect the strength of the electric wave that is transmitted from a wireless communication terminal and received through the leaky coaxial cable; and
a control module configured to execute data transmission to the wireless communication terminal by transmitting electric wave through the leaky coaxial cable if the strength of the electric wave detected by the detection module is equal to or greater than a set value, and to change the set value according to time.

2. The wireless communication apparatus according to claim 1, wherein:
the control module does not execute data transmission to the wireless communication terminal by transmitting the electric wave through the leaky coaxial cable if the detected strength of the electric wave is less than the set value, and changes the set value for a plurality of time zones in one day.

3. The wireless communication apparatus according to claim 1, wherein:
the detection module detects the strength of the electric wave transmitted from the wireless communication terminal in response to the transmission of electric wave from the leaky coaxial cable within the electric wave received through the leaky coaxial cable.

4. The wireless communication apparatus according to claim 1, wherein:
the detection module periodically transmits the electric wave including a beacon from the leaky coaxial cable, and detects the signal strength of the beacon included in the electric wave which is transmitted from the wireless communication terminal in response to the periodically transmission within the electric wave received through the leaky coaxial cable.

5. The wireless communication apparatus according to claim 1, further comprising:
an attenuator configured to attenuate the electric wave transmitted from the leaky coaxial cable.

6. The wireless communication apparatus according to claim 1, further comprising:
a transmission output setter configured to set the strength of the electric wave transmitted from the leaky coaxial cable.
